(19) United States
(12) Patent Application Publication
(10) Pub. No.: US 2007/0295172 A1
(43) Pub. Date: Dec. 27, 2007

(54) Fastener Holding Device

(76) Inventor: Darian Swartz, Vernon (CA)

Correspondence Address: MCGLEW & TUTTLE, PC, P.O. BOX 9227, SCARBOROUGH STATION, SCARBOROUGH, NY, 10510-9227, US

(21) Appl. No.: 11/426,253

(22) Filed: Jun. 23, 2006

(51) Int. Cl. B25B 23/10; B25B 23/08

(52) U.S. Cl. 81/451; 81/452

(57) ABSTRACT

A sleeve for retaining a fastener against a driver bit includes a resiliently flexible shaft sleeve for frictional engagement against a driver shaft. A lower sleeve is provided having an inner diameter size for engagement over and around the head of a fastener.

### FIELD OF THE INVENTION

The present invention relates generally to a system and kit for securing a fastener (such as a screw) to a driver (such as a screwdriver) to facilitate one-handed use of the driver in both fastening and un-fastening operations.

### BACKGROUND OF THE INVENTION

In the use of fastener-drivers (hereafter a “driver” or “drivers”), users often seek ways to ensure that the fastener remains fixed to the driver. More specifically, at many times, a user desires to use only one hand to apply pressure to the fastener as a result of the desired placement or location of the fastener. In situations where the desired placement of the fastener is on a vertical work surface or a work surface below the driver, the user must usually hold the fastener against the driver to ensure that it does not fall off the driver during positioning. Alternatively, the user must use steady hand movements while placing the fastener against the work surface. While some fasteners or drivers (such as a Robertson driver and fastener) have specific surfaces or properties allowing the fastener and driver to remain gently attached to one another, the fastener may often fall off the driver if a critical angle is reached, the user inadvertently touches another surface with the fastener or as a result of unsteady hand or body movements by the user.

In the past, one solution to this problem has been the use of magnets within the driver which can increase the relative strength of connection between the driver and fastener. However, as a magnet requires that a corresponding fastener is magnetic, magnet tip drivers are limited to use with magnetic fasteners. Magnet tip drivers also have a tendency to pick up stray metal filings in and around work projects that must be periodically cleaned from the driver. Still further, magnet tip drivers are not suitable around magnet- and electrically sensitive areas where live wires may be employed. A magnet tip driver may also be unnecessarily bulky thereby limiting its use in certain applications.

Other past solutions have included screwstarters and screw guides. Screwstarters utilize either a spring-loaded or manually actuated multi-sectioned bit to apply opposing pressures to opposite sides of a fastener. However, these systems are limited to either a specific fastener style or a relatively small number of fastener styles. Moreover, these systems are relatively expensive compared to a single component driver. Screw guides are spring loaded rigid sleeves that are biased over the tip of a driver and that retract up and over the shaft as a fastener is advanced into a surface. These systems are generally limited to a particular size fastener head and are not interchangeable between different bits.

### SUMMARY OF THE INVENTION

In accordance with the invention, there is provided a sleeve for retaining a fastener against a driver bit comprising: a resiliently flexible shaft sleeve for frictional engagement against a driver shaft; and, a lower sleeve having an inner diameter size for engagement over and around the head of a fastener.

In one embodiment the lower sleeve includes a lower edge and an inner lip adjacent the lower edge for engagement over the fastener head. In other embodiments, the lower sleeve includes at least two inner protruding lips and/or an inwardly tapering surface and/or the shaft sleeve includes at least one inner protruding lip.

In a still further embodiment, the invention provides a kit for securing a fastener to a drive shaft, the kit comprising a plurality sleeves as described, each sleeve having a different upper sleeve inside diameter.

Further still, the invention provides a driver for securing a sleeve as described wherein the driver includes a head having a recess for receiving and storing the sleeve.

### BRIEF DESCRIPTION OF THE DRAWINGS

Embodiments of the invention will be described, by way of example with reference to the attached Figures, wherein:

FIG. 1 is a cross-sectional view of a fastener holding system in accordance with one embodiment of the invention;

FIG. 2 is a cross-sectional view of a fastener holding system in accordance with an alternate embodiment of the invention;

FIG. 2B is a cross-sectional view of a fastener holding system in accordance with an alternate embodiment of the invention wherein the lower sleeve has a tapered surface; and,

FIG. 3 is a cross-sectional view of a driver head in accordance with an embodiment of the invention wherein the driver head has a recess for storing a sleeve.

### DETAILED DESCRIPTION

With reference to the Figures, an elastic and flexible polymeric sleeve 10 used to retain fasteners 5 against the bit surfaces 11 of a driver 11a.

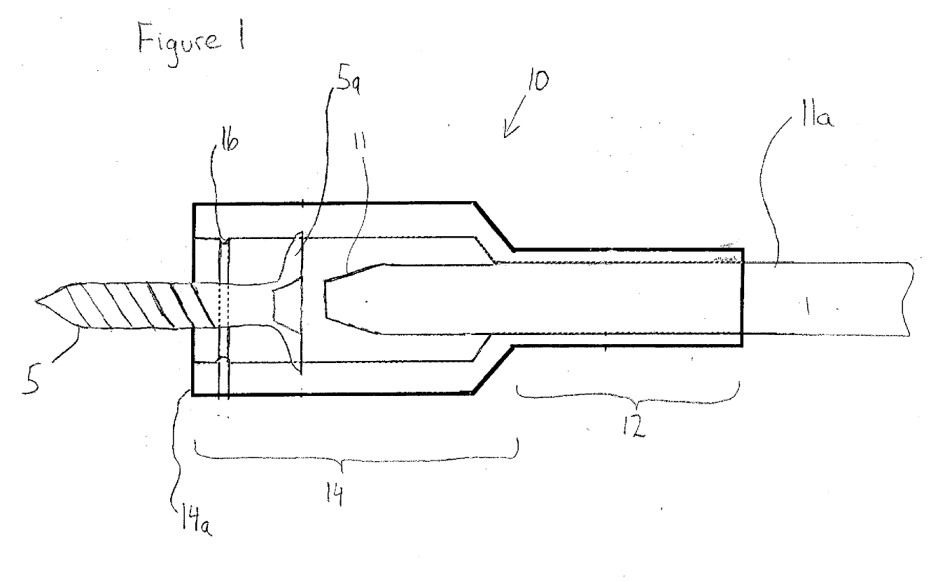

As shown in FIG. 1, the sleeve 10 includes a shaft sleeve 12 for frictional engagement around the shaft of a driver 11a (such as a screwdriver shaft) and a lower sleeve 14 generally having an outside diameter greater than the outside diameter of the shaft sleeve. The shaft sleeve generally has an inside diameter corresponding to the outer diameter of the driver shaft 11a while the lower sleeve has an inside diameter which allows the lower sleeve to be placed over the head 5a of a fastener 5. In a preferred embodiment, the inner surface of the lower sleeve is provided with a circumferential retaining lip 16 adjacent the lower edge 14a.

In operation, a user places a sleeve 10 over and around the shaft 11a of a driver and positions the lower edge 14a of the lower sleeve so that it protrudes slightly beyond the lower tip of the driver bit. By placing a fastener 5 having a head diameter slightly larger than the inside diameter of the lower lip 16, a fastener is firmly held against the bit surfaces. By virtue of the elastic and flexible nature of the lower sleeve, variations in fastener head diameter can be accommodated by a single sleeve as shown in FIG. 1 where the outside diameter of the fastener head 5a is shown to slightly depress the inner surfaces of the lower sleeve.

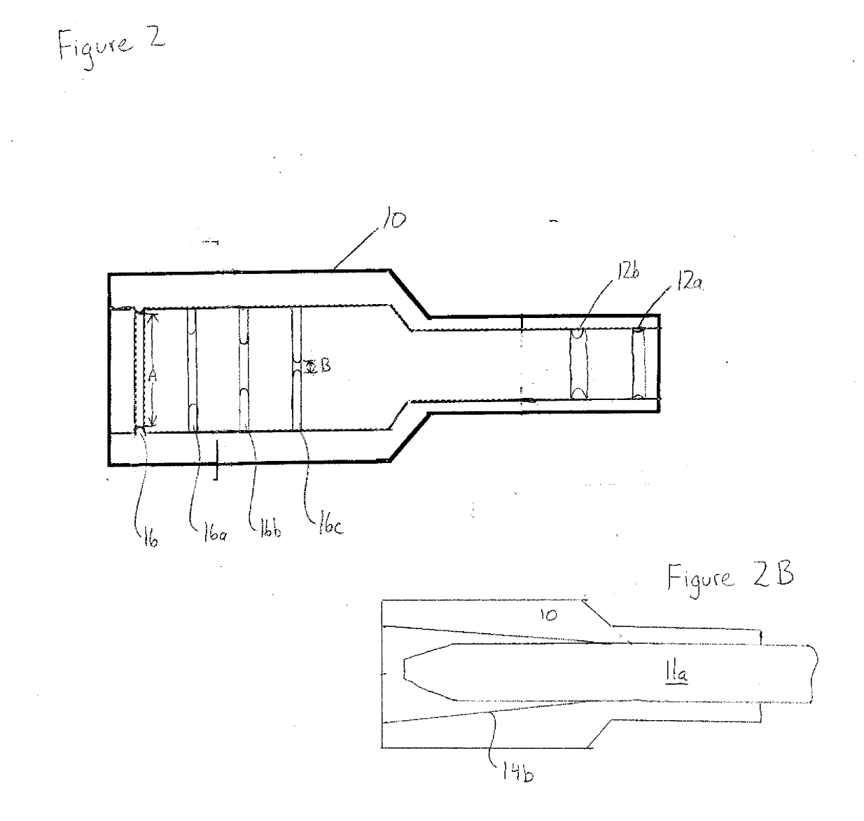

Similarly, due to the elastic and flexible nature of the sleeve 10, shaft sleeve 12 may be retained against a range of shaft diameters. Particularly, in one embodiment of the invention, the shaft sleeve may further comprise its own inner protruding lip 12a or lips 12a, 12b that would be sized to be effective on a wider of range of shaft diameters as shown in FIG. 2.

### Use

The invention is most useful when a user either has a single or limited number of fastening jobs to complete within a confined or awkward space where the use of two hands to initiate the fastening process is difficult. For example, if a user is working within a confined space and cannot hold a fastener in one hand against the work surface while connecting the driver to the fastener, the invention is particularly useful. In this scenario, a user would place the shaft sleeve over the shaft of the driver and position the sleeve 10 at the appropriate location as described above. The fastener 5 would be inserted within the lower sleeve and retained against the bit surface. Any adjustments required to ensure that the fastener and bit surfaces are fully engaged would be made. The user is then able to confidently use one hand to properly locate the fastener against the work surface, apply the fastening pressure and complete the fastening process.

In repeated use, where a user wishes to complete a larger number of fastenings using an identical fastener, after initially setting up the sleeve 10 in its proper position, the user can confidently complete each successive fastening while quickly and easily inserting a new fastener into the lower sleeve as each fastening is completed.

As the fastening process proceeds, the head of the fastener will begin to engage against the work surface. Due to the flexible and elastic nature of the lower sleeve and inner lip, as well as the tapering surfaces of a typical fastener head as shown in FIG. 1, the lower sleeve will expand to allow the inner lip 16 to be pushed away from and around the outer diameter of the head 5a without pinching. As the lower lip 16 is cleared from the fastener head and the fastening process continues, the fastener will become fully engaged and/or countersunk against/within the work surface without damage to the sleeve. However, it should be noted that over time, particularly with the use of electric drivers, the lower edge of the sleeve may be worn out as a result of friction with the work surface. However, the sleeve can be readily replaced with a new sleeve. Naturally, the nature of the work surface will contribute to the longevity of a particular sleeve where smoother surfaces where the abrasive forces are less will contribute to a longer life for a particular sleeve.

The sleeve may also be used in removing fasteners from work surfaces particularly where there is a risk of dropping the fastener as it is removed from the work surface. In this case, the above steps are performed in reverse with the result that when the fastener head has been withdrawn a distance sufficient to allow the lower sleeve to engage the head, the lower sleeve will automatically “pop-over” and engage with the head so that by continued turning and eventual disconnection of the fastener with the work surface the sleeve retains the fastener.

### Materials and Manufacture

The sleeve may be fabricated from polymeric materials having a range of properties. Typically, the sleeve will be manufactured in an injection molding process from any suitable elastic polymeric material such as but not being limited to nylons, rubbers and polyurethanes that allow the sleeve to perform the desired functions of gripping both the shaft and fastener. In one embodiment the sleeve is a clear or partially clear silicone polymer so as to allow the user to observe the positioning and degree of engagement between the fastener head and the bit during both initial set up and repeated use.

The polymeric material may also be manufactured with luminescence which may assist in illuminating a dark work area or be colour coded or imprinted with a symbol(s) to allow a user to quickly identify a driver type.

### Further Embodiments

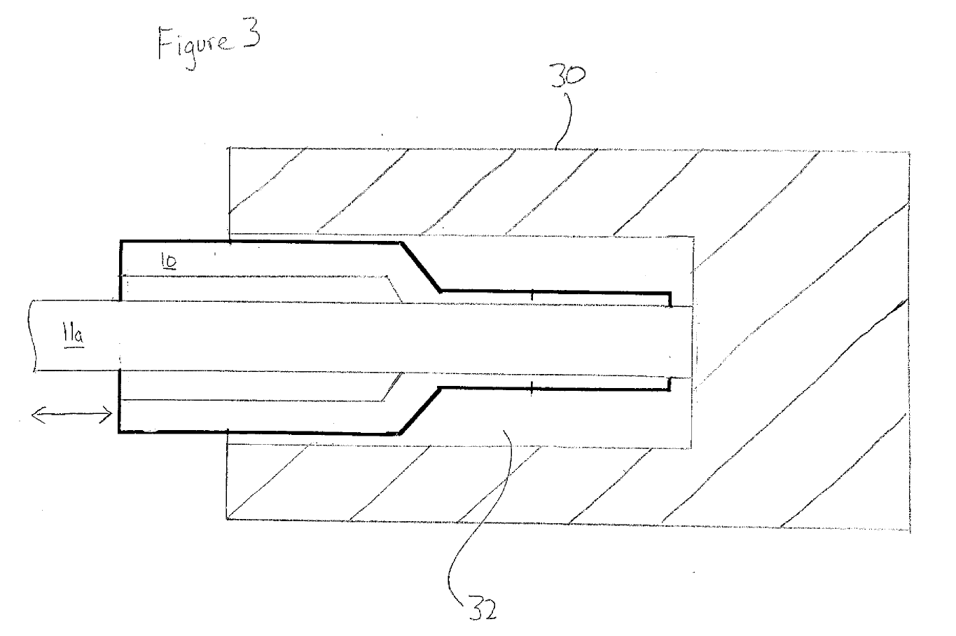

In a still further embodiment, the driver may be modified to allow the storage of a sleeve within the head of the driver. With reference to FIG. 3, a typical driver head 30 is shown having a recess 32 for allowing the sleeve to be withdrawn up the shaft and stored fully or partially within the driver head. In this embodiment, a user may push the sleeve 10 up into recess 32 when the sleeve is not required and then withdraw the sleeve from the recess by grasping a small protruding portion of the sleeve to slide the sleeve down the shaft 11a for use.

In a still further embodiment, the lower sleeve may be provided with a plurality of inner lips each of a different inner diameter. As shown in FIG. 2, a lower sleeve is shown to include four successive inner lips 16, 16a, 16b, 16c ranging from the largest diameter opening A at the lower edge to a smaller inner diameter opening B closer to the shaft sleeve. In this embodiment, the sleeve can therefore accommodate a larger number of head diameters of various fasteners. During use of this embodiment, in the event that a smaller diameter head is being used and is retained against the upper most inner lip, the lower regions of the lower sleeve will compress against the fastening surface as the fastener head approaches the fastening surface. Alternatively, a user may choose to cut away the lower regions of the sleeve so that less of the lower sleeve is compressed.

In a still further embodiment, the lower sleeve is provided with a continuous inner tapered surface 14b as shown in FIG. 2B that can accommodate a range of fastener heads. In this embodiment, a fastener head is inserted within the lower sleeve to a position where it is snugly engaged within the lower sleeve.

The invention may be used with a variety of drive shafts and bits. Shafts may be round or multi-faceted and may be of different lengths to be effective.

The sleeve has been tested and found to be effective with a wide range of fastener types and head styles including Phillips, Torq-Set, Torx, Torx Plus, Tri-Wing, Hex, Hex external, 12pt (internal), 12pt (external), Slotted, Robertson, Clutch, Posi, Decorative Knurl, Tri-Angle, Robertson/Slotted, Phillips (External Hex), Drilled Head, Opsit, Truss, Binding, Fillistar, Oval, Round, Flat, Pan, Washer, Cheese, Cap, Button, Thumbscrew and Set-Screw Fasteners.

Further still, the sleeve is effective in holding female style fasteners including nuts, caps, hex, bubble, serrated, pal, square, sleeve, barrel, MS, twist-off collars and “tampruf” fasteners. In addition, the sleeve is effective with sockets and can be particularly useful in holding both a washer and nut within a socket before tightening over a bolt.

As well, hose-clamps can be held positioned and tightened with the sleeve effectively holding the clamp for the procedure.

The above-described embodiments of the present invention are intended to be examples only. Alterations, modifications and variations may be effected to the particular embodiments by those of skill in the art.

1. A sleeve for retaining a fastener against a driver bit comprising:
a resiliently flexible shaft sleeve for frictional engagement against a driver shaft; and,
a lower sleeve having an inner diameter size for engagement over and around the head of a fastener.

2. A sleeve as in claim 1 wherein the lower sleeve includes a lower edge and an inwardly projecting inner lip adjacent the lower edge for engagement over the fastener head.

3. A sleeve as in claim 1 wherein the lower sleeve includes at least two inner inwardly protruding lips.

4. A sleeve as in claim 1 wherein the lower sleeve includes an inwardly tapering surface.

5. A sleeve as in claim 1 wherein the shaft sleeve includes at least one inner inwardly protruding lip.

6. A sleeve as in claim 4 wherein the shaft sleeve includes at least one inner inwardly protruding lip.

7. A sleeve as in claim 1 wherein the sleeve is manufactured from a clear material.

8. A sleeve as in claim 7 wherein the sleeve is clear silicone rubber.

9. A sleeve as in claim 1 wherein the sleeve is manufactured from a luminescent material.

10. A sleeve for retaining a fastener against a driver bit comprising:
a resiliently flexible shaft sleeve for frictional engagement against a driver shaft; and,
a lower sleeve having an inner diameter size for engagement over and around the head of a fastener, the lower sleeve including a lower edge and at least one inwardly projecting inner lip adjacent the lower edge for engagement over the fastener head.

11. A kit for securing a fastener to a drive shaft the kit comprising a plurality sleeves as in claim 1 each sleeve having a different upper sleeve inside diameter.

12. A driver for securing a sleeve as in claim 1 wherein the driver includes a head having a recess for receiving and storing the sleeve.
